(19) United States
(12) Patent Application Publication
(10) Pub. No.: US 2025/0188367 A1
(43) Pub. Date: Jun. 12, 2025

(54) PROCESSING A HYDROCARBON USING PYROLYSIS, METHOD AND APPARATUS

(71) Applicant: MONTANUNIVERSITÄT LEOBEN, Leoben (AT)

(72) Inventors: Andreas SPRUNG, Trofaiach (AT); Helmut ANTREKOWITSCH, Leoben (AT); David NEUSCHITZER, Leoben (AT); David SCHEIBLEHNER, Graz (AT); Stefan WIBNER, Semriach (AT)

(21) Appl. No.: 18/845,714

(22) PCT Filed: Mar. 11, 2022
(86) PCT No.: PCT/EP2022/056379

§ 371 Date: Sep. 10, 2024

(51) Int. Cl. C10G 9/18

(52) U.S. Cl. CPC C10G 9/18

(57) ABSTRACT

It is described a method of processing a hydrocarbon, in particular a hydrocarbon gas, the method comprising:
i) preheating the hydrocarbon in a preheater device;
ii) providing the preheated hydrocarbon to a liquid metal bath in a reactor device, wherein the liquid metal bath comprises at least one catalyst; and
iii) performing a pyrolysis reaction with the hydrocarbon in the liquid metal bath, so that a carbon phase and hydrogenare obtained.

### CROSS-REFERENCE TO RELATED APPLICATION

The present application is a U.S. National Phase Patent Application of International Patent Application Number PCT/EP2022/056379, filed on Mar. 11, 2022, the entire content of which is incorporated herein by reference.

### FIELD OF THE DISCLOSURE

The disclosure relates to a method of processing a hydrocarbon using a pyrolysis process, in particular within a liquid metal bath. Further, the disclosure relates to an apparatus configured to perform said method.

### TECHNICAL BACKGROUND

In order to counteract the progression of climate change and its effects on the ecosystem, it is an object to minimize carbon dioxide (CO₂) emissions by further developing the energy-producing systems worldwide. It is assumed that hydrogen may play a central role in prospective, CO₂ minimized, energy-production systems. The question remains, nevertheless, how a large amount of hydrogen can be produced in an environmentally friendly manner. For example, electrolysis produces hydrogen from water (2 H₂O<->O₂+2 H₂), however, requires a high amount of energy.

Methane (CH₄) resembles another promising source of hydrogen formation. Hydrogen can be obtained from methane for example by steam reforming, yet CO₂ will be produced in this manner (CH₄+2H₂O<->CO₂+4H₂). Another concept to obtain hydrogen from methane is the pyrolysis of methane to hydrogen and carbon (CH₄<->2H₂+C). Pyrolysis may be considered an especially interesting technology, because significantly less energy is required as in the case of electrolysis, while there is no CO₂ production as in reforming. The reaction of methane gas into hydrogen gas and solid carbon can be improved by using a catalyst, in particular within a liquid bath. Nevertheless, providing an energy-efficient and environmentally friendly pyrolysis process may still be considered a challenge.

### SUMMARY OF THE DISCLOSURE

There may be a need to process a hydrocarbon, in particular to yield hydrogen, in an efficient, energy-saving, and environmentally friendly manner.

A method of manufacturing and an apparatus are described.

According to an aspect of the disclosure, it is described a method of processing a hydrocarbon, in particular a hydrocarbon gas, the method comprising:
i) preheating the hydrocarbon in a preheater device;
ii) providing the preheated hydrocarbon to a liquid metal bath in a reactor device, wherein the liquid metal bath comprises at least one catalyst, in particular a metal catalyst; and
iii) performing a pyrolysis reaction with the hydrocarbon in the liquid metal bath, so that a carbon phase (in particular a solid carbon phase) and a hydrogen phase (in particular a gaseous hydrogen phase) are obtained.

According to a further aspect of the disclosure, it is described an apparatus for processing a hydrocarbon, the apparatus comprising:
i) a preheater device for preheating the hydrocarbon;
ii) a reactor device, coupled with the preheater device, and configured for performing a pyrolysis reaction with the preheated hydrocarbon in a liquid metal bath, so that a carbon phase and a hydrogen phase are obtained.

According to a further aspect of the disclosure, it is described a method of processing a hydrocarbon, in particular a hydrocarbon gas, the method comprising:
i) providing the (preferably preheated) hydrocarbon to a liquid metal bath in a reactor device, wherein the liquid metal bath comprises at least one catalyst; and
ii) performing a pyrolysis reaction with the hydrocarbon in the liquid metal bath, so that a carbon phase (in particular a solid carbon phase) and a hydrogen phase (in particular a gaseous hydrogen phase) are obtained.

In the context of this document, the term “hydrocarbon” may particularly denote an organic compound/substance (which may be solid, liquid, or gaseous) that comprises (essentially) hydrogen and carbon. While a hydrocarbon may comprise in one example only hydrogen and carbon, a hydrocarbon may in another example contain further chemical elements such as e.g. oxygen or nitrogen. Yet, hydrogen and carbon are generally the main components of a hydrocarbon. A hydrocarbon may comprise or consist of a gas, a liquid, a solid, or a mixture thereof. Examples of hydrocarbons may include: methane, biogas, natural gas, pyrolysis gas, carbonization gas from scrap pyrolysis, pre-pyrolysis gas, landfill gas, crude oil, mineral oil, pyrolysis oil, bio-oil, liquid industrial waste hydrocarbons, plastic waste, industrial residues, organically contaminated metal scraps. In a specific example, a hydrocarbon may be mainly solid or liquid, but can be turned into a gaseous hydrocarbon during a pre-pyrolysis reaction.

In the context of this document, the term “liquid metal bath” may particularly denote a mass of fully or partially molten metals. In an example, the liquid metal bath comprises a base metal (e.g. copper, iron) with at least one active metal, wherein the active metal is a metal catalyst (e.g. nickel). The metal bath may comprise mainly metal, but may also contain further substances. The term “reactor device” may refer in this context to any device suitable to accommodate the liquid metal bath (and to perform a pyrolysis reaction therein). A hydrocarbon may be introduced as a reactant into the metal bath and undergo a pyrolysis reaction triggered by heat (and eventually pressure) and the metal catalyst. In an example, the hydrocarbon may be transported through the bath (in particular in the vertical direction from below to above) and thereby constantly undergo the pyrolysis reaction. In a specific example, the hydrocarbon reacts thereby to a solid phase and a gaseous phase. Hereby, the gas phase may be transported through the metal bath as bubbles, while the solid phase may form a layer on top of the liquid metal bath.

In the context of this document, the term “catalyst” may particularly denote a substance that increases the rate of a chemical reaction, when added to the substance(s) that should chemically react. If the catalyst substance comprises or consists of one or more metals, it may be termed a “metal catalyst”. For example, a metal catalyst can be a single component system, e.g. nickel. Further, the metal catalyst may also be a multicomponent system. In an embodiment, the liquid metal bath comprises or consists of the metal catalyzer. Thus, a pyrolysis reaction in the reactor device may (essentially) occur in the liquid metal bath. The reaction can take place only in the bath or also (at least partially) outside (above) the bath. Within the bath, the catalyst (e.g. metal and/or (solid) carbon) may be completely or partially liquid.

In the context of this document, the term “pyrolysis reaction” may particularly denote any reaction that includes a decomposition of a substance caused by heat. Pyrolysis may be seen as the thermal decomposition of substances/materials at elevated temperatures and may involve a change of the chemical composition of the substance. In the present context, the term pyrolysis may also include a thermolysis, wherein a thermolysis may be a specific pyrolysis that aims to yield specific products by thermal decomposition (instead of merely breaking down all substances). A specific example in this context may include the pyrolysis of a hydrocarbon such as methane to a carbon phase and a hydrogen phase.

In the context of this document, the term “preheater device” may particularly denote any device suitable to heat a hydrocarbon, in particular to a specific temperature. The pre-heater device may be coupled to a reactor device and may heat the hydrocarbon so that the pre-heated hydrocarbon can be provided to the reactor device. The pre-heater device may be (directly) coupled with the reactor device. Further, the pre-heater device may be configured as a transportation line. The pre-heater device may comprise or be coupled with e.g. a (encapsulated) heating line, a (porous) heat exchanger, a (graphite) chute. In another example, the hydrocarbon may be preheated in the first place and then transported to the reactor device in the second place. The temperature in the pre-heater device may be comparable to the temperature of the reactor device, but may also be lower or even higher. The skilled person may know many ways of how to design a heating device, whereby a heating with inductor coils may be a preferred solution. The pre-heater device may comprise an inlet for the hydrocarbon and an outlet for the preheated hydrocarbon. The last may be coupled with or integrated in the inlet of the reactor device, e.g. a gas purge unit.

In the context of this document, the term “hydrogen phase” may denote a phase that comprises or consists of hydrogen. While, in one example the hydrogen phase may only contain (gaseous) hydrogen, in another example, the hydrogen phase contains further substances. The other substances (e.g. polyaromatic hydrocarbons (PAH) as a by-product from CH₄ decompensation (e.g. acetylene->benzene->PAH)) may be removed during a subsequent purification process.

In an example, there may be three different hydrogen(-rich) phases present during the described process:
a hydrogen-rich gas stream, in particular a gas phase that may be loaded with solid carbon dust and/or metal particles/droplets. The hydrogen rich gas stream may be present directly after the liquid metal bath (and until a (hot gas) filter process step).
a hydrogen-rich gas phase, in particular a gas phase after the (hot gas) filter, which comprises hydrogen and further gaseous components (e.g. no complete CH₄ decompensation). The hydrogen-rich gas phase may be further processed, e.g. by a condensor and/or a membrane.
a hydrogen-rich phase that comprises a high purity of hydrogen. The hydrogen rich phase may occur in the described method after a membrane process step.

In the context of this document, the term “carbon phase” may denote a phase that comprises or consists of carbon, in particular solid carbon. In one example, the carbon phase comprises only carbon, but in another example, the carbon phase further comprises other substances.

According to an exemplary embodiment, the disclosure may be based on the idea that a hydrogen-rich phase can be produced from a hydrocarbon in an efficient, energy-saving, and environmentally friendly manner, when the hydrocarbon is provided to a preheating process, before it is pyrolyzed in a liquid bath that comprises a metal catalyst.

It has been found by the inventors, that preheating the hydrocarbon, before introducing it into the pyrolysis reactor, may significantly improve the efficiency of the pyrolysis reaction. The aim may be hereby, to design the hydrocarbon processing as energy-efficient as possible, thereby reducing the needed material to a minimum. The preheated hydrocarbon may immediately react, when introduced into the liquid metal bath with the metal catalyzer, to the hydrogen phase and the carbon phase. These phases rise up (e.g. with(in) bubbles) within the liquid metal bath and can be collected for further purification processes. By performing essentially the whole pyrolysis reaction with preheated hydrocarbon within the liquid metal bath, the yield (of the pyrolysis reaction) may be maximized, while energy requirements may be minimized. The described approach may be implemented in existing metallurgical plants in a straightforward manner, since the process takes place under industry-related conditions (e.g. 900-1600° C., <50 bar). Up-scaling may thus be done in an easy manner.

A major advantage of this process may be seen in a significantly lower amount of energy required. This energy can be provided from renewable sources (or even other metallurgical plant processes), resulting in a much smaller CO₂ footprint for the hydrogen produced in this way compared to e.g. steam reforming.

### DESCRIPTION OF EXEMPLARY EMBODIMENTS

According to an embodiment, the method further comprises heating the liquid metal bath and/or the preheating device by induction. In particular, thereby inducing a movement in the liquid metal bath. Through a defined arrangement and control of the induction coils, the electromagnetic forces may be applied such that desired parameters (bath movement, bubble size, and residence times of the gases in the bath) may be provided. Thus, the heating by induction may not only heat the metal bath in an efficient manner, it may also enable a selective adjustment of advantageous parameters that further improve the efficiency of the process. The preheated hydrocarbon may thereby directly take part in the induced movement without cooling/slowing down the dynamics in the metal bath.

According to a further embodiment, the method further comprises applying a cover layer above the liquid metal bath, in particular comprising at least one of a slag, stable oxides, solid oxides (e.g. spheres of Al₂O₃), a salt melt, a carbon. It may be possible to control the hydrocarbon-containing gases as well as the discharge behavior of the resulting solids by applying a covering layer on the surface of the metal bath. This may provide the advantage that it may be avoided that metal drops leave the metal bath, thereby saving resources.

According to a further embodiment, providing the hydrocarbon further comprises injecting the hydrocarbon into the reactor by at least one of the group which consists of a lance, a porous tube, a purge block, an impeller. The different systems for gas injection (as well as the electromagnetic forces by induction) may allow to influence the bath movement, bubble size and gas residence times, which may ensure a significant increase in the conversion of the discharged gases. The input of hydrocarbon (-containing gases) into the liquid metal bath may take place via one or more units containing different gas injection systems, such as lances, purge blocks, impellers or porous tubes as well as systems for gas preheating. The configuration of these units may be variable, so that a targeted influence on the bath movement, bubble sizes, and residence times of the gases in the bath may be possible.

According to a further embodiment, the pyrolysis reaction is performed at a temperature of 1600° C. or less. In particular, in a range from 600° C. to 1600° C., more in particular in a range from 900° C. to 1400° C., more in particular in a range from 1000° C. to 1200° C. In another example, in a range from 900° C. to 1200° C. or 600° C. to 900° C. Hence, energy-and reaction-efficient temperatures may be advantageously adapted to the required needs.

In an example, a range 600° C. to 900° C. may be applied for tin (Sn) as base metal, a range 900° C. to 1200° C. may be applied for copper as base metal, and a range of 1200° C. to 1600° C. may be applied for iron or nickel as base metal. Thus, the temperature can be accurately adjusted to the requirements of the applied base metal. While a low temperature may serve energy in the first place, a higher temperature may enable a faster reaction and/or higher yield, thus potentially saving more energy on a longer time scale.

According to a further embodiment, preheating is performed at a temperature of 900° C. or less, in particular in a range 600° C. to 900° C. Accordingly, the hydrocarbon can be brought to the same or at least to a temperature close to the temperature of the liquid metal bath. This may provide the advantage that the reaction yield is increased, while energy costs can be saved. In an example, the preheating temperature is lower than the temperature of the liquid metal bath. Preheating the input gas by using the process heat from the pyrolysis process, or another process, can save costs. In another example, the thermal energy from the melt is used only, or mainly for CH₄ decomposition and not for heating the gas to process temperature.

According to a further embodiment, the pyrolysis reaction is performed in a technical vacuum or at a pressure of 1 bar or more, in particular 5 bar or more, in particular 10 bar or more, in particular 40 bar or more, more in particular 50 bar or less. In an example, the pressure may be in the range 1 to 60 bar, in particular 5 to 60 bar, in particular in the range 10 to 50 bar. Depending on the applied pressure, the reaction may be advantageously accelerated.

According to a further embodiment, the method further comprises injecting the preheated hydrocarbon as a gas into the reactor device at an injection orifice, wherein the preheated hydrocarbon forms bubbles at the injection orifice which rise up within the liquid metal bath. As can be seen in FIG. 1, in one example, the bubbles may comprise a small size near the injection orifice, while they continuously grow in size while moving up within the liquid metal bath. During the pyrolysis reaction, the hydrocarbon produces a solid carbon phase, that may precipitate at the surface of the bath, and a gas phase, that comprises a gas and a solid, and moves with(in) the bubbles to the surface of the liquid metal bath. Carbon may stick (adhere) to a bubble (flotation effect) and/or be inside of the bubble. In the metal bath, there may be a reaction of CH₄ to 2H₂, whereby the metallostatic pressure decreases, the temperature rises, and a coagulation occurs. In an example, the bubbles may become smaller during rising due to H₂ or CH₄ solubility of the metal bath catalyst or by reaching a critical size.

According to a further embodiment, at least a part of the carbon phase is in solid form and floats on the liquid metal bath, and the method further comprises discharging the carbon phase, in particular by at least one of mechanic conveyance, pneumatic conveyance, gravitational conveyance. As described above, the carbon phase may at least partially precipitate/float on the bath, thereby forming a cover layer. The cover layer may have advantageous effects (e.g. avoiding that material (metal drops, particles, etc.) leaves the metal bath) on the liquid metal bath and may be collected in a straightforward manner.

According to a further embodiment, the method further comprises separating the carbon phase in solid form from a hydrogen rich gas stream, in particular, by at least one of a filter, in particular a hot gas filter, a gravity separator. As described above, a hydrogen rich gas stream (after the metal bath) may contain a solid (carbon phase) and a gas (hydrogen phase) (in other words; a hydrogen-containing gas mixture and a carbon-containing solid fraction), whereby, the solid is transported in the gas like in a stream to the surface of the bath. This may provide the advantage that the (main) solid part (a further part may remain at the bottom and/or as a suspension) does not remain in the bath, but is transported to the surface, where it may be efficiently separated from the hydrogen phase. In this manner, it may be prevented that the catalyst is deactivated/contaminated. Known and established means such as (hot gas) filtering and/or gravity separation may be applied herefore.

According to a further embodiment, the method further comprises processing the hydrogen-rich gas stream (e.g. to obtain a hydrogen-rich gas phase, in particular hydrogen gas), in particular by at least one of filtering, condensation, compression, membrane separation, quenching. Additionally or alternatively to the process described above, the hydrogen-rich gas stream (hydrogen phase to be processed) can be (further) processed by e.g. a condenser (see FIG. 1) (and optionally a police filter). The hydrogen-rich gas phase may be configured as a gas phase that may be loaded with solid carbon dust and/or metal particles/droplets. The filter/condenser may be applied to efficiently separate the hydrogen (phase) from solid carbon phase (dust) and/or the metal particles/drops and/or gaseous synthesis products that occur as solid or liquid condensates in the condenser. By-pass gases (e.g. nitrogen) may be applied as cleaning gases that transport carbon phase from the metal bath surface.

According to an exemplary example, the resulting solid fraction is separated from the product gas flow via a hot gas filter. The further treatment of the produced gas includes the process steps quenching, for condensing certain hydrocarbons, compression and separation of the remaining gases from the hydrogen via a membrane.

According to a further embodiment, the (metal) catalyst comprises at least one of the group which consists of Cu, Ni, Sn, Al, Ga, In, Bi, Fe, Co, Si, C, Pt, Rh, Ir, Pd, Au, Ag or a mixture thereof. Thus, industrially relevant materials may be directly applied as catalyzers within the liquid metal bath. The pyrolysis reaction is based on the thermal decomposition of the introduced (gaseous) components in catalytically active, pure metals as listed above, or in multi-substance systems which may include binary, ternary and quaternary combinations of the metals. The metals may be present e.g. in elementary form, oxide, sulphide or carbide. By using the metal combinations mentioned, an optimal catalytic treatment effect may be enabled.

According to a further embodiment, the (metal) catalyst comprises or consists of one of a binary multicomponent system, a ternary multicomponent system, a quaternary multicomponent system. According to a further embodiment, the metal catalyst comprises at least one catalytically active metal within at least one base metal (e.g. at least one of tin, copper, iron). In another example, the metal catalyst comprises only the catalytically active metal.

According to a further embodiment, the (metal) catalyst is essentially not deactivated or consumed during the pyrolysis reaction.

According to a further embodiment, the reactor is configured as a bubble column reactor or as a hearth furnace. Thus, industrially relevant and established technologies can be directly applied for the described approach. Straightforward adaption of existing systems, e.g. metallurgical plants, may be enabled. The relevant processes may be carried out in inductively heated units, which can be designed as a bubble column reactor or as a hearth furnace. The units may operate independently or (at least partially) in series.

According to a further embodiment, the hydrocarbon comprises (or consists of) a gas that comprises or consists of at least one of methane, biogas, natural gas, pyrolysis gas, carbonization gas from scrap pyrolysis, landfill gas. Thus, a plurality of hydrocarbon gases may be directly introduced into the pyrolysis process.

According to a further embodiment, the hydrocarbon comprises or consists of a liquid that comprises or consists of at least one of crude oil, mineral oil, pyrolysis oil, bio-oil, liquid industrial waste hydrocarbons. Thus, a plurality of liquid hydrocarbons (even waste material) may be introduced into the pyrolysis process.

According to a further embodiment, the hydrocarbon comprises or consists of a solid that comprises or consists of at least one of plastic waste, industrial residues, organically contaminated metal scrap. Thus, a plurality of solid hydrocarbons (even waste material) may be introduced into the pyrolysis process.

According to a further embodiment, the method further comprises: i) providing the hydrocarbon containing solid and/or liquid to a pre-pyrolysis device, ii) performing a pre-pyrolysis (carbonization) reaction in the pre-pyrolysis device, so that a (pre-pyrolyzed) hydrocarbon containing gas is obtained, and iii) providing the (pre-pyrolyzed) hydrocarbon containing gas (generated in the pre-pyrolysis device) to the pre-heater device and/or to the reactor device. This may provide the advantage that solid/liquid hydrocarbons may be provided to the described pyrolysis in an especially efficient manner. The pre-pyrolysis may yield a gaseous hydrocarbon that may be introduced into the preheater/reactor device together or instead of the normal gaseous hydrocarbon. The pre-pyrolysis device may be configured as a preheater device that produces an especially high temperature (and pressure) to enable the pre-pyrolysis reaction. In another example, the pre-pyrolysis device may comprise a (metal) catalyzer, in particular within a further liquid metal bath (e.g. a two step process, in particular with the pre-pyrolysis device configured as a further reactor device).

According to a further embodiment, the method further comprises providing the hydrocarbon with the solid, in particular grains, and/or the liquid through a feeding device into the liquid metal bath of the reactor device (or into the pre-pyrolysis device, or into the preheater device). In particular by at least one of mechanical conveyance, pneumatic conveyance, gravitational conveyance. This may provide the advantage that solid/liquid hydrocarbons may be provided to the described pyrolysis in an especially efficient manner. Additionally or alternatively to the pre-pyrolysis, hydrocarbons may be directly introduced into the metal bath. The feeding device may for example comprise a hopper and/or an extruder, which may be especially suitable if the hydrocarbon solids comprise grains. The hydrocarbons may not be further processed in the feeding device. Nevertheless, the feeding device may also comprise pre-processing means, for example the feeding device may be coupled with the pre-heater device.

According to a further embodiment, the method is performed continuously or discontinuously (batch-wise). Both operation modes may provide specific advantages, but there may also be a change between continuous operation times and discontinuous operation times.

According to a further embodiment, the method further comprises at least partially processing the carbon phase, in particular a solid fraction of the carbon phase, more in particular by at least one of classifying, sorting, metallurgical refining, activating.

According to a further embodiment, the method further comprises adjusting the morphology of the solid fraction of the carbon phase, in particular by at least one of introducing solid carbon particles, changing an alloy, changing the temperature, changing the pressure, changing the residence time of the hydrocarbon in the reactor device, changing the cover layer.

According to a further embodiment, the method is performed in an industrial metallurgical plant, and the method further comprises using excess heat energy from at least one further unit of the industrial metallurgical plant. This measure may enable a specifically efficient energy management and may be environmentally friendly. In an example, a known and established industrial metallurgical plant may be adapted to the described method in a straightforward manner. Thereby, costs and efforts may be saved.

### BRIEF DESCRIPTION OF THE DRAWINGS

The aspects defined above and further aspects of the disclosure are apparent from the examples of embodiment to be described hereinafter and are explained with reference to these examples of embodiment.

FIG. 1 shows an apparatus for processing a hydrocarbon according to an exemplary embodiment of the disclosure.

FIG. 2 shows an apparatus for processing a hydrocarbon according to a further exemplary embodiment of the disclosure.

### DETAILED DESCRIPTION OF THE DRAWINGS

The illustrations in the drawings are schematic. In different drawings, similar or identical elements are provided with the same reference signs.

Before, referring to the drawings, exemplary embodiments will be described in further detail, some basic considerations will be summarized based on which exemplary embodiments of the disclosure have been developed.

According to an exemplary embodiment, pure metals, such as for example Cu, Ni, Sn, Al, Ga, In, Bi, Fe, Si, or multicomponent systems containing binary, ternary and quaternary combinations of the above elements, as well as their sulfidic or carbidic compounds, serve as catalysts (or heat transfer media to get a pyrolysis reaction started). The metals can act as heat exchangers and can also have a catalytic effect, which favors thermal decomposition, which requires less energy. The temperature of the metal bath is e.g. 900-1600° C., and the pressure in the furnace chamber can be increased in an example up to 50 bar. The introduction of the hydrocarbon containing gases into the molten bath is carried out by one or more units, which include different ways of gas introduction, such as lances, purge blocks, impellers or porous pipes, as well as systems for gas preheating. The following gases can be introduced into the metal bath reactor: methane, biogas, natural gas, pyrolysis gas or carbonization gas from scrap pyrolysis. The bath movement, bubble size and residence times of the gases in the melt can be specifically influenced by the defined arrangement of the purge units and the positioning and control of the induction coils.

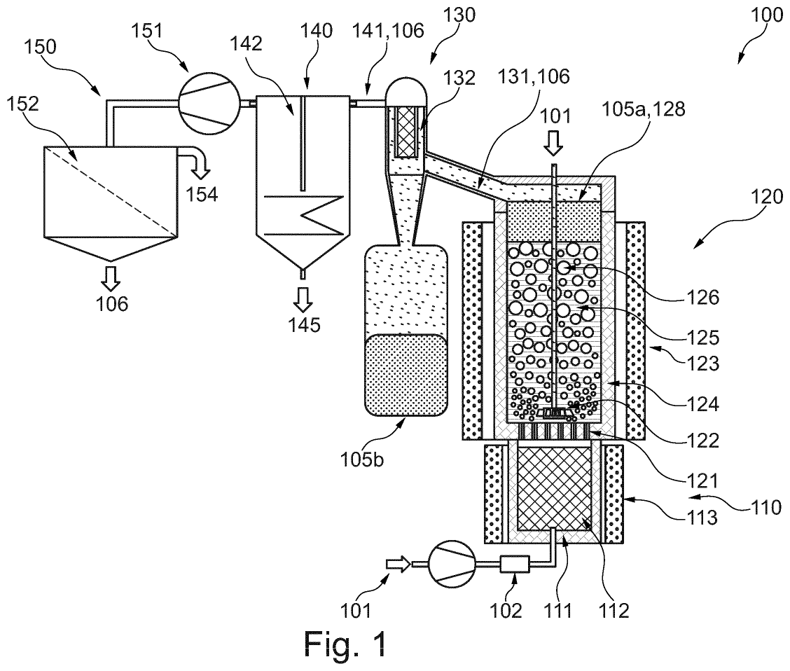

FIG. 1 shows an apparatus 100 for processing a hydrocarbon 101 according to an exemplary embodiment of the disclosure. The hydrocarbon 101 can be provided in this example preferably in a gaseous form. In the exemplary example described here, the hydrocarbon is provided as methane gas. The hydrocarbon 101 is introduced to a preheater device 110 via a compressor. The preheater device 110 comprises a preheater vessel 111 that delimits a preheater chamber 112 in which the hydrocarbon (gas) 101 is preheated. In the present example, the preheater device 110 further comprises inductor coils 113 arranged around the preheater chamber 112 and configured to heat the hydrocarbon 101 within the chamber 112. The hydrocarbon can be preheated to a temperature of e.g. 900° C. or less.

The preheated hydrocarbon 101 is then transferred to a reactor device 120 via an injection orifice or a purge block 121. The reactor device 120 is configured here as a bubble column reactor. The reactor device 120 comprises a reactor vessel 124 that delimits a reaction chamber that is in turn filled with a liquid metal bath 125. Said bath 125 comprises a metallic catalyzer to support the actual pyrolysis reaction of the preheated hydrocarbon 101 within the bath 125. Like the preheater device 110, the reactor device 120 comprises inductor coils 123 around the reactor chamber. The coils 123 are configured to provide the heat for melting the metal, thereby providing the molten metal liquid bath 125, and to establish a specific desired reaction temperature, e.g. 1600° C. or less. Further, the coils 123 can introduce a movement in the liquid metal bath 125, thereby favoring the pyrolysis reaction. The reactor device 120 further comprises a stirring/impeller unit 122 that introduces a further movement and distribution of the hydrocarbon 101 in the liquid metal bath 125. Further, the stirring/impeller unit 122 comprises in this example a further hydrocarbon (gas) input 101. The preheated hydrocarbon forms bubbles 126 at the injection orifice 121 which rise up within the liquid metal bath 125. The pyrolysis reaction is performed essentially in the liquid metal bath 125 in a technical vacuum or at a pressure of 10 bar or more (or 10 bar or less).

Furthermore, a cover layer 128 is formed above the liquid metal bath 125 in order to avoid that a part of the liquid metal bath, in particular the catalyzer, is lost. In the example shown, the cover layer 128 comprises a layer of solid carbon 105a from the pyrolysis reaction that floats on the surface of the liquid metal bath 125. Besides the solid carbon that floats on the liquid metal bath 125, the pyrolysis reaction produces a hydrogen-rich gas stream. The solid carbon can be partially discharged by this hydrogen-rich gas stream, whereby a mixture of solid carbon and the hydrogen-rich gas phase are obtained. Carbon can be part of the gas phase, but forms a gas-solid mixture with the hydrogen-rich gas phase, whereby part of the carbon can be discharged. This can depend on the morphology and fineness of the carbon.

Said gas (hydrogen-rich gas stream is transferred via a discharge section for gas and carbon 131 to a filter device 130. The filter device 130 comprises a hot gas filter 132 configured to filter and dispatch the discharged solid carbon phase 105b in a storage section. The obtained hydrogen phase 141 is to be further processed since it contains by-products besides the hydrogen gas 106. Thus, the hydrogen phase to be processed 141 is transferred to a condenser device 140, wherein it is cooled to a certain temperature at a condenser plate 142. In order to condensate the gaseous substances (intermediate products, synthesis products) of the hydrogen phase to be processed 141, temperatures between +300° C. und −50° C. can be suitable. Further, the condenser device 140 can be configured as a condenser column, which may enable fractionation of said substances, e.g. PAKs).

By this processing, certain components of the hydrogen-rich gas phase can be separated 145 as a liquid or solid condensate to be processed 141. For further gas cleaning, the hydrogen-rich gas phase to be processed 141 is compressed (at 151) and provided to a membrane separator device 150. The membrane separation process 152 separates further by-products 154 and yields the desired pure hydrogen gas 106 (hydrogen-rich phase).

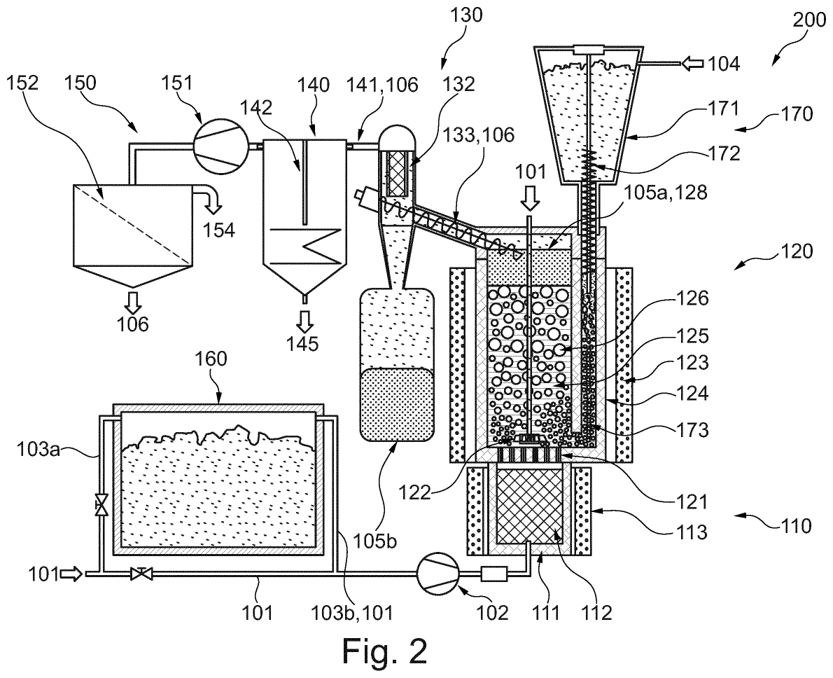

FIG. 2 shows an apparatus 200 for processing a hydrocarbon 101 according to a further exemplary embodiment of the disclosure. The apparatus 200 is very similar to the one described for FIG. 1 above. However, while the apparatus 100 of FIG. 1 is mainly configured to process a hydrocarbon 101 that comprises gas (gaseous hydrocarbon), the apparatus 200 of FIG. 2 is specifically configured to process also a hydrocarbon that comprises a solid and/or a liquid.

The apparatus 200 comprises a pre-pyrolysis device 160 that is arranged before (process-upstream of) the preheater device 110. While a gaseous hydrocarbon 101 is directly introduced into the preheater device 110, a hydrocarbon with a solid/liquid (e.g. plastic waste, oil, etc.) content 103a is provided to the pre-pyrolysis device 160. It is performed therein a pre-pyrolysis reaction, so that a pre-pyrolyzed hydrocarbon 103b is obtained that comprises essentially gas and is therefore also denoted as 101. The obtained hydrocarbon 103b, generated in the pre-pyrolysis device 160, is then introduced, together with the gaseous hydrocarbon 101, into the pre-heater device 110.

Additionally, or alternatively, apparatus 200 further comprises a feeding device 170 for feeding a hydrocarbon with a solid/liquid directly into the liquid metal bath 125 of the reactor device 120. In the example shown, the hydrocarbon 104 comprises solids in the form of fine grains that are provided through a hopper 171 to a feeding extruder 172. A syphon 173 is arranged between sidewalls of the reactor device 120, so that the extruder 172 can transport (in a combination of mechanical and gravitational conveyance) the fine grained hydrocarbon 104 directly through the syphon 173 into the liquid metal bath 125. While apparatus 100 comprises a pneumatic discharge section for gas and carbon 131 between reactor device 120 and filter device 130, apparatus 200 of FIG. 2 comprises here a pneumatic-mechanical discharge section 133 for gas and carbon, wherein the carbon is discharged continuously by mechanical conveyance.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

Implementation of the disclosure is not limited to the preferred embodiments shown in the figures and described above. Instead, a multiplicity of variants are possible which use the solutions shown and the principle according to the disclosure even in the case of fundamentally different embodiments.

### REFERENCE SIGNS

100 Apparatus
101 Hydrocarbon
102 Mass flow control device
103a Hydrocarbon with solid/liquid
103b Pre-pyrolyzed hydrocarbon
104 Hydrocarbon with solid grains
105a Carbon phase, solid floating
105b Carbon phase, solid stored
106 Hydrogen phase, gaseous
110 Preheater device
111 Preheater vessel
112 Preheater reaction chamber, preheated hydrocarbon
113 Preheater inductor coil
120 Reactor device
121 Injection orifice, purge block
122 Stirring or impelling unit
123 Reactor inductor coil
124 Reactor vessel
125 Liquid metal bath
126 Gas bubbles
128 Protection/cover layer
130 Filter device
131 Discharge section for gas and carbon
132 Hot gas filter
133 Discharge section
140 Condenser device
141 Hydrogen phase to be processed
142 Condenser plate
145 Condensate, oil
150 Membrane filter device
151 Compressor for gas cleaning
152 Membrane separator
154 By-product gas
160 Pre-pyrolysis device
170 Feeding device
171 Hopper
172 Extruder
173 Feeding syphon
200 Further apparatus

1.-26. (canceled)

27. A method of processing a hydrocarbon, the method comprising:
preheating the hydrocarbon in a preheater device;
providing the preheated hydrocarbon to a liquid metal bath in a reactor device, wherein the liquid metal bath comprises at least one catalyst; and
performing a pyrolysis reaction with the hydrocarbon in the liquid metal bath, so that a carbon phase and a hydrogen phase are obtained.

28. The method according to claim 27, further comprising:
heating at least one of
the liquid metal bath
the preheating device
by induction.

29. The method according to claim 28,
wherein the heating by induction induces a movement in the liquid metal bath.

30. The method according to claim 27, further comprising:
applying a cover layer above the liquid metal bath, in particular comprising at least one of a slag, an oxide melt, a salt melt, a carbon.

31. The method according to claim 27, wherein providing the hydrocarbon further comprises:
injecting the hydrocarbon into the reactor by at least one of a lance, a porous tube, a purge block, an impeller.

32. The method according to claim 27,
wherein the pyrolysis reaction is performed at a temperature of 1600° C. or less, in particular in a range from 600° C. to 1600° C., more in particular in a range from 900° C. to 1400° C., more in particular in a range from 1000° C. to 1200° C.

33. The method according to claim 27,
wherein the preheating is performed at a temperature of 900° C. or less.

34. The method according to claim 27,
wherein the pyrolysis reaction is performed at a pressure of 1 bar or more, in particular 5 bar or more, in particular 10 bar or more, more in particular 40 bar or more, more in particular 50 bar or less.

35. The method according to claim 27, wherein the method further comprises:
injecting the preheated hydrocarbon as a gas into the reactor device at an injection orifice;
wherein the preheated hydrocarbon forms bubbles at the injection orifice which rise up within the liquid metal bath.

36. The method according to claim 27, further comprising at least one of the following features:
wherein the hydrocarbon comprises a hydrocarbon gas;
wherein the catalyst comprises a metal catalyst;
wherein the pyrolysis reaction is performed in a technical vacuum;
wherein at least a part of the carbon phase is in solid form and floats on the liquid metal bath;
wherein the method further comprises: discharging the carbon phase,
in particular by at least one of mechanic conveyance, pneumatic conveyance, gravitational conveyance;
wherein the method further comprises: separating the carbon phase in solid form from a hydrogen rich gas stream,
in particular by at least one of a filter, in particular a hot gas filter, a gravity separator;
wherein the method further comprises: processing the hydrogen rich gas stream,
in particular by at least one of filtering, condensation, compression, membrane separation, quenching;
wherein the catalyst comprises at least one of the group which consists of Cu, Ni, Sn, Al, Ga, In, Bi, Fe, Si, Co, C, Pt, Rh, Ir, Pd, Au, Ag or a mixture thereof;
wherein the catalyst comprises or consists of one of a binary multicomponent system, a ternary multicomponent system, a quaternary multicomponent system,
in particular wherein the metal catalyst comprises at least one catalytically active metal within at least one base metal;
wherein the catalyst is essentially not deactivated during the pyrolysis reaction;
wherein the reactor is configured as a bubble column reactor or as a hearth furnace.

37. The method according to claim 27,
wherein the hydrocarbon comprises a gas that comprises or consists of at least one of methane, biogas, natural gas, pyrolysis gas, carbonization gas from scrap pyrolysis, pre-pyrolyzed gas, landfill gas.

38. The method according to claim 27,
wherein the hydrocarbon comprises a liquid,
in particular a liquid that comprises or consists of at least one of crude oil, mineral oil, pyrolysis oil, bio-oil, liquid industrial waste hydrocarbons.

39. The method according to claim 27,
wherein the hydrocarbon comprises a solid,
in particular a solid that comprises or consists of at least one of plastic waste, industrial residues, organically contaminated metal scrap.

40. The method according to claim 38, further comprising:
providing the hydrocarbon with the solid and/or the liquid to a pre-pyrolysis device;
performing a pre-pyrolysis reaction in the pre-pyrolysis device, so that a pre-pyrolyzed hydrocarbon is obtained; and
providing the pre-pyrolyzed hydrocarbon to the pre-heater device and/or to the reactor device.

41. The method according to claim 38, further comprising:
providing the hydrocarbon with the solid, in particular grains, and/or the liquid through a feeding device into the liquid metal bath of the reactor device, in particular by at least one of mechanical conveyance, pneumatic conveyance, gravitational conveyance.

42. The method according to claim 27,
wherein the method is performed continuously or batch-wise.

43. The method according to claim 27, further comprising:
at least partially processing the carbon phase,
in particular a solid fraction of the carbon phase, more in particular by at least one of classifying, sorting, metallurgical refining, activating.

44. The method according to claim 43, further comprising:
adjusting the morphology of the solid fraction of the carbon phase,
in particular by at least one of introducing solid carbon particles, changing an alloy, changing the temperature, changing the pressure.

45. The method according to claim 27, wherein the method is performed in an industrial metallurgical plant, and wherein the method further comprises:
using excess heat energy from at least one further unit of the industrial metallurgical plant.

46. An apparatus for processing a hydrocarbon, the apparatus comprising:
a preheater device for preheating the hydrocarbon;
a reactor device, coupled with the preheater device, and configured for performing a pyrolysis reaction with the preheated hydrocarbon in a liquid metal bath, so that a carbon phase and a hydrogen phase are obtained.

47. The method according to claim 39, further comprising:
providing the hydrocarbon with the solid and/or the liquid to a pre-pyrolysis device;
performing a pre-pyrolysis reaction in the pre-pyrolysis device, so that a pre-pyrolyzed hydrocarbon is obtained; and
providing the pre-pyrolyzed hydrocarbon to the pre-heater device and/or to the reactor device.
